(19) United States
(12) Patent Application Publication
(10) Pub. No.: US 2009/0116045 A1
(43) Pub. Date: May 7, 2009

(54) SYSTEM AND METHOD FOR DRIVER-BASED IMAGE MANIPULATION

(76) Inventors: Barry TRAN, Canley Heights (AU); Lilian Ji, Burwood (AU); Chaminda Weerasinghe, Bella vista (AU); Yasuhiro Ohashi, St. Ives Chase (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/250,973

(22) Filed: Oct. 14, 2008

Related U.S. Application Data
(60) Provisional application No. 60/985,709, filed on Nov. 6, 2007.

(51) Int. Cl. G06K 15/02

(52) U.S. Cl. 358/1.9

(57) ABSTRACT

The subject application is directed to a system and method for device-specific image manipulation. First, output device capability data corresponding to capabilities of available document output devices is stored in associated memory. Electronic document data having image data corresponding to a plurality of sub-images is then received. Device selection data is then received corresponding to a selected document output device. Capability data representing the output capabilities of the selected device is then retrieved. Image characteristic data is then determined and tested relative to the device output capability data. Selected sub-images are then merged into a single image and the image is classified in accordance with the image characteristic data. Resolution and colorant reduction are then determined in accordance with the testing output. The determined resolution and colorant reductions are then applied to the single image of the received electronic document data and output by the selected document output device.

### CROSS-REFERENCE TO RELATED APPLICATIONS

This Application claims priority to U.S. Provisional Patent Application No. 60/985,709, filed Nov. 6, 2007, the entirety of which is hereby incorporated by reference.

### BACKGROUND OF THE INVENTION

The subject application is directed to a system and method for intelligent image processing. More particularly, the subject application is directed to a system and method for device-specific image manipulation. In particular, the subject application is directed to a system and method for determining resolution and colorant reduction in accordance with classified input images targeted to a specific document output device.

Current computer operating systems, such as the WINDOWS VISTA operating system produced by MICROSOFT CORPORATION implement a print path based on eXtensible Markup Language (XML) Paper Specification files (XPS). An XPS file, or document, describes an electronic document in such a manner that it is readily understood by hardware and software, as well as in human readable form. Such a document format provides substantial flexibility in terms of document composition and document size. The production of XPS documents by various applications often result in documents having a plurality of redundancies and larger performance constraining image items.

Document output devices typically perform a print operation, facsimile operation, scan operation, copy operation. A device capable of performing two or more of these operations is commonly called a multifunction peripheral device. The multifunction peripheral device is generally enabled for high performance print and quality outputs. However, the resources available to such multifunction peripheral devices, particularly when a print operation has invoked, are limited, thus requiring printer drivers to properly process large XPS documents. Conventional printer drivers typically apply the same image processing algorithms to all input image types in documents, which may result in sub-optimal outputs including a loss in quality, a reduction in performance, and the like.

Image manipulation within an XPS print path is problematic due to extensive use of image splitting in XPS print documents supported by a plurality of different applications. The XPS specification, as will be known to those skilled in the art, does not restrict the use of image splitting, since the XPS file format is applicable not only to printing, but also to portable electronic document applications. XPS, with particular emphasis on web-based applications, provides benefits in terms of gradual loading of sub-images (split images), rather than as a single, monolithic image. In document processing, however, the raster image processor, embedded within an associated document output device, must then decode a plurality of images, resulting in a print file that is larger than a corresponding print file wherein the sub-images are merged into a single image. Thus, the processing of a file by a document output device containing split or sub-images is time consuming and resource intensive. Furthermore, the XPS file sent to the document output device does not contain device specific details, resulting in Raster image Processor (RIP) residing within the controller or other component associated with the document output device to accurately render the XPS file.

The application producing the XPS file or document is typically unaware of the capabilities of the output device, e.g. display, printer, multifunction peripheral, etc., the images included in such a file are usually stored at the highest resolution possible. While such high resolution storage is beneficial for maintaining image quality over many devices of varying capabilities, the file includes a multitude of redundant image information making the print file very large and the corresponding output very slow. For example, when an image embedded within a given XPS file is of 4800 dots per inch (dpi) with cyan, magenta, yellow, black (CMYK) colorants, and the targeted document output device is only capable of 600 dpi monochromatic (black and white) output, the file size is 256 times oversized for the document output device. Thus, it is possible to reduce the image size by at least 256 times (i.e. (4800/600)×(4800/600)×(4/1)) without affecting the visual quality of the printed output from the targeted printer, by applying appropriate resolution and colorant reduction techniques. However, such processing needs to be determined based on the characteristics of the input image, such as, for example and without limitation, edge content and distribution, number of colors, dominant color, color distribution, and the like

### SUMMARY OF THE INVENTION

In accordance with one embodiment of the subject application, there is provided a system and method for classifying input images for resolution reduction. Output device capability data corresponding to the capabilities of output devices is first stored in associated memory. Electronic document data is then received that includes image data representing a multiple sub-images. Selection data corresponding to a selection of at least one selected output device is then received from an associated user. Output device capability data is then retrieved from the associated memory corresponding to at least one capability associated with the output device in accordance with the received output device selection data. Image characteristic data is then determined corresponding to the plurality of sub-images. The retrieved output device capability data associated with the selected output device is then tested relative to the determined image characteristic data. The plurality of sub-images of the image data are then merged into a single image in accordance with the determined image characteristic data associated therewith. The merged single image is then classified in accordance with the determined image characteristic data. Resolution reduction is then determined in accordance with an output of the testing of output device capability data associated with the selected output device relative to determined image characteristic data. Colorant reduction is then determined based upon an output of the testing of output device capability data associated with the selected output device relative to determined image characteristic data. The determined resolution and colorant reductions are then applied to the merged image data of the received electronic image data. Thereafter, the electronic document data is communicated to the selected document output device.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for device-specific image manipulation according to one embodiment of the subject application;

FIG. 2 is a block diagram illustrating device hardware for use in the system for device-specific image manipulation according to one embodiment of the subject application;

FIG. 3 is a functional diagram illustrating the device for use in the system for device-specific image manipulation according to one embodiment of the subject application;

FIG. 4 is a block diagram illustrating controller hardware for use in the system for device-specific image manipulation according to one embodiment of the subject application;

FIG. 5 is a functional diagram illustrating the controller for use in the system for device-specific image manipulation according to one embodiment of the subject application;

FIG. 6 is a block diagram illustrating a workstation for use in the system for device-specific image manipulation according to one embodiment of the subject application;

FIG. 7 is a functional block diagram illustrating the system and method for device-specific image manipulation according to one embodiment of the subject application;

FIG. 8 is a flowchart illustrating a method for device-specific image manipulation according to one embodiment of the subject application;

FIG. 9 is a flowchart illustrating a method for device-specific image manipulation according to one embodiment of the subject application;

FIG. 10 is a screen shot illustrating fixed-page directory locations in an XPS file according to one example embodiment of the system for device-specific image manipulation of the subject application;

FIG. 11 is a clip path example for use in the system for device-specific image manipulation according to one example embodiment of the subject application;

FIG. 12 is an example of path and imagebrush elements in a fixedpage file for use in the system for device-specific image manipulation according to one example embodiment of the subject application;

FIG. 13 is an example of a reference image and candidate images for use in the system for device-specific image manipulation according to one example embodiment of the subject application;

FIG. 14 is an example of non-continuous image content over adjacent sub-images for use in the system for device-specific image manipulation according to one example embodiment of the subject application; and

FIG. 15 is an example of an anti-aliasing filter for use in the system for device-specific image manipulation according to one example embodiment of the subject application.

### DETAILED DESCRIPTION OF THE PREFERRED EMBODIMENT

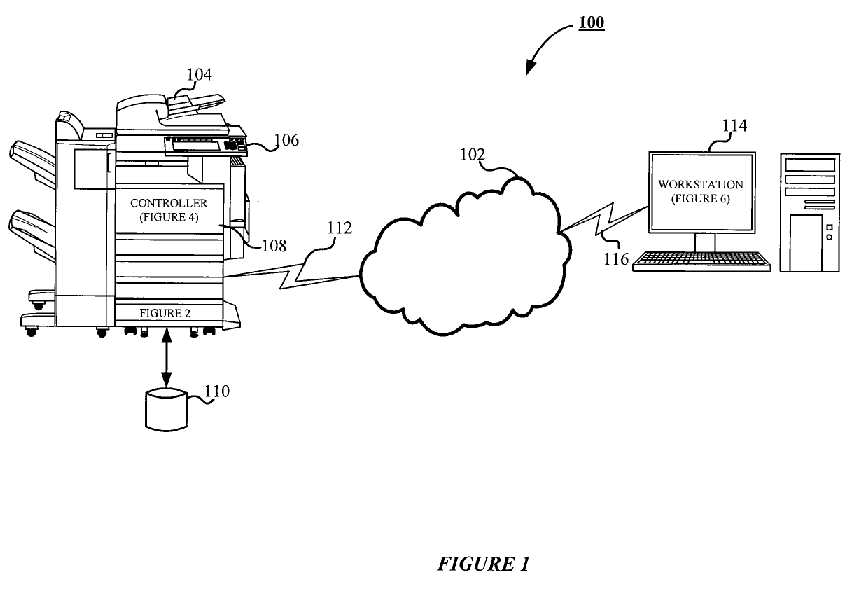

The subject application is directed to a system and method for classifying input images for resolution reduction. In particular, the subject application is directed to a system and method for determining an extent of resolution and colorant reduction. More particularly, the subject application is directed to a system and method for determining resolution and colorant reduction in accordance with classified input images targeted to a specific document output device. It will become apparent to those skilled in the art that the system and method described herein are suitably adapted to a plurality of varying electronic fields employing image manipulation, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for device-specific image manipulation in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

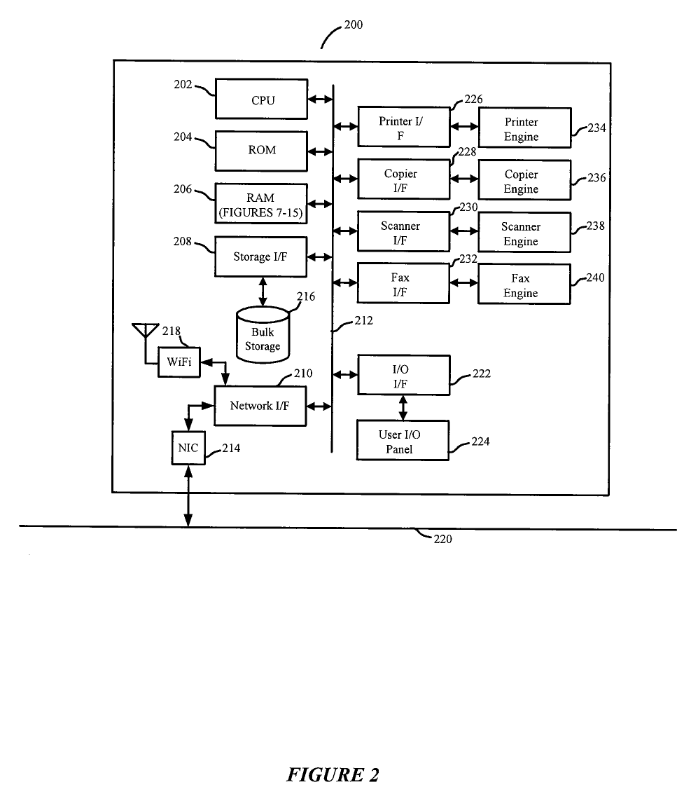

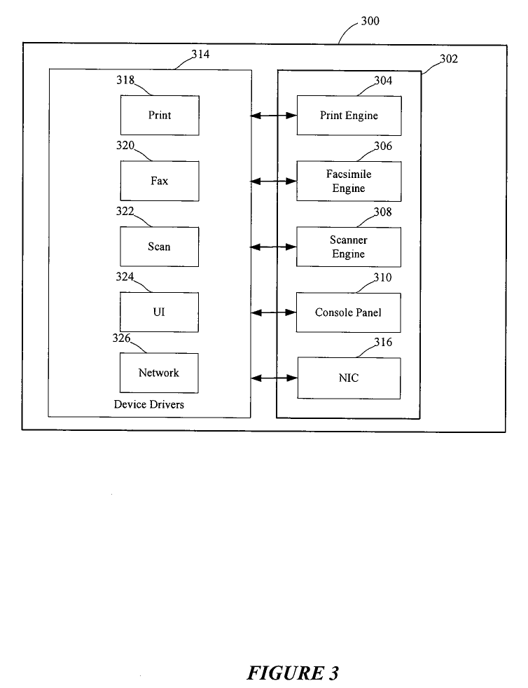

The system 100 also includes a document output device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document output devices include, for example and without limitation, the Toshiba e-Studio Series Controller. In accordance with one aspect of the subject application, the document output device 104 is suitably adapted to provide remote document processing services to external or network devices. Preferably, the document output device 104 includes hardware, software, and any suitable combination thereof, configured to interact with an associated user, a networked device, or the like. The functioning of the document output device 104 will be better understood in conjunction with the block diagrams illustrated in FIGS. 2 and 3, explained in greater detail below.

According to one embodiment of the subject application, the document output device 104 is suitably equipped to receive a plurality of portable storage media, including, without limitation, Firewire drive, USB drive, SD, MMC, XD, Compact Flash, Memory Stick, and the like. In the preferred embodiment of the subject application, the document output device 104 further includes an associated user interface 106, such as a touch-screen, LCD display, touch-panel, alpha-numeric keypad, or the like, via which an associated user is able to interact directly with the document output device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document output device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

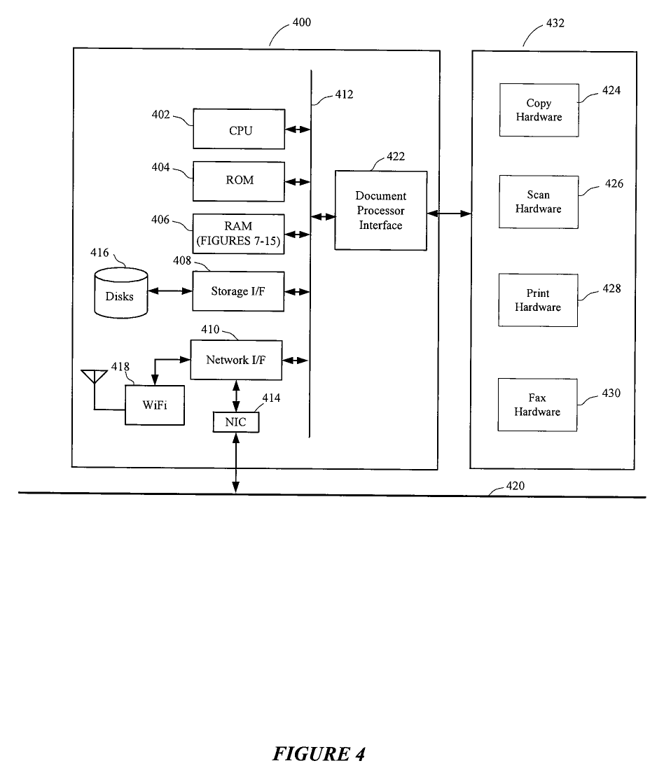

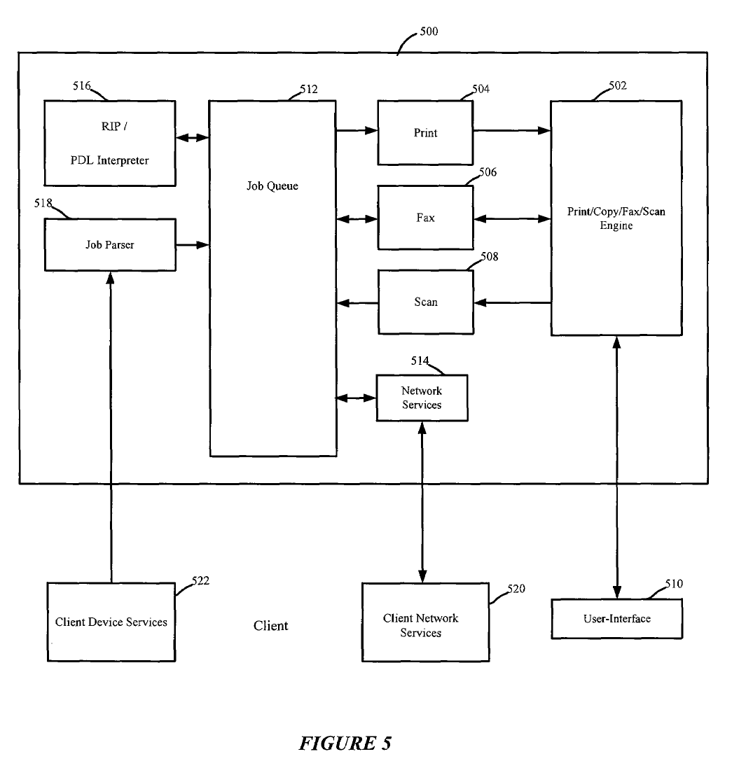

In accordance with one embodiment of the subject application, the document output device 104 further incorporates a backend component, designated as the controller 108, suitably adapted to facilitate the operations of the document output device 104, as will be understood by those skilled in the art. Preferably, the controller 108 is embodied as hardware, software, or any suitable combination thereof, configured to control the operations of the associated document output device 104, facilitate the display of images via the user interface 106, direct the manipulation of electronic image data, and the like. For purposes of explanation, the controller 108 is used to refer to any myriad of components associated with the document output device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for device-specific image manipulation of the subject application. The functioning of the controller 108 will better be understood in conjunction with the block diagrams illustrated in FIGS. 4 and 5, explained in greater detail below.

Communicatively coupled to the document output device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document output device 104, a component of the controller 108, or the like, such as, for example and without limitation, an internal hard disk drive, or the like.

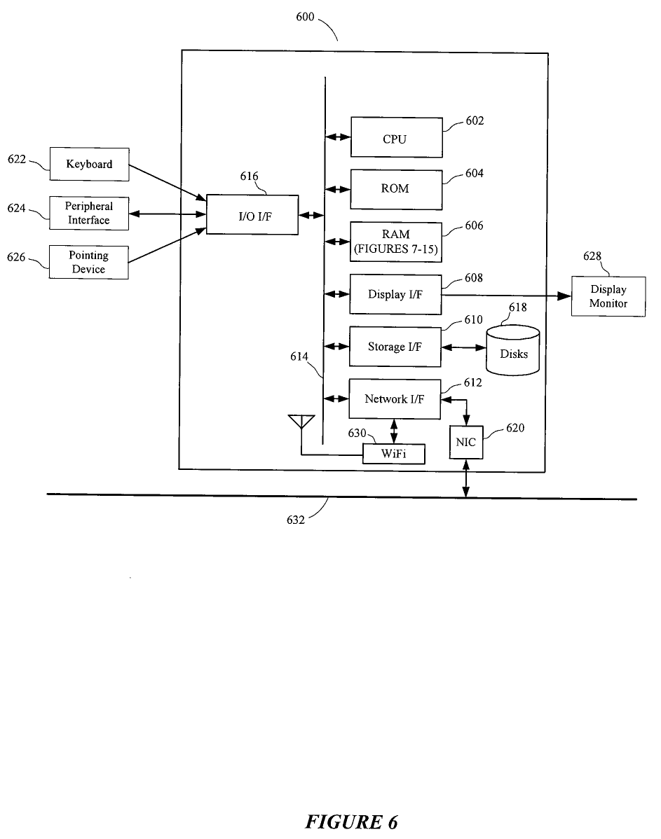

The system 100 illustrated in FIG. 1 further depicts a workstation 114, in data communication with the computer network 102 via a communications link 116. It will be appreciated by those skilled in the art that the workstation 114 is shown in FIG. 1 as a computer workstation for illustration purposes only. As will be understood by those skilled in the art, the workstation 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 114 is suitably adapted to generate and transmit electronic documents, document processing instructions, user interface modifications, upgrades, updates, personalization data, or the like, to the document output device 104, or any other similar device coupled to the computer network 102. The functioning of the workstation 114 will better be understood in conjunction with the block diagrams illustrated in FIG. 6, explained in greater detail below.

Turning now to FIG. 2, illustrated is a representative architecture of a suitable device 200, (shown in FIG. 1 as the document output device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document output devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document output device, (shown in FIG. 1 as the document output device 104), for use in connection with the disclosed system. FIG. 3 illustrates suitable functionality of the hardware of FIG. 2 in connection with software and operating system functionality as will be appreciated by one of ordinary skill in the art. The document output device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document output device, such as the document output device 104, which include the controller 400 of FIG. 4, (shown in FIG. 1 as the controller 108) as an intelligent subsystem associated with a document output device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document output devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a job parser 518, which job parser suitably functions to receive print job language files from an external device, such as client device services 522. The client device services 522 suitably include printing, facsimile transmission, or other suitable input of an electronic document for which handling by the controller function 500 is advantageous. The job parser 518 functions to interpret a received electronic document file and relay it to the job queue 512 for handling in connection with the afore-described functionality and components.

Turning now to FIG. 6, illustrated is a hardware diagram of a suitable workstation 600 (shown in FIG. 1 as the workstation 114) for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

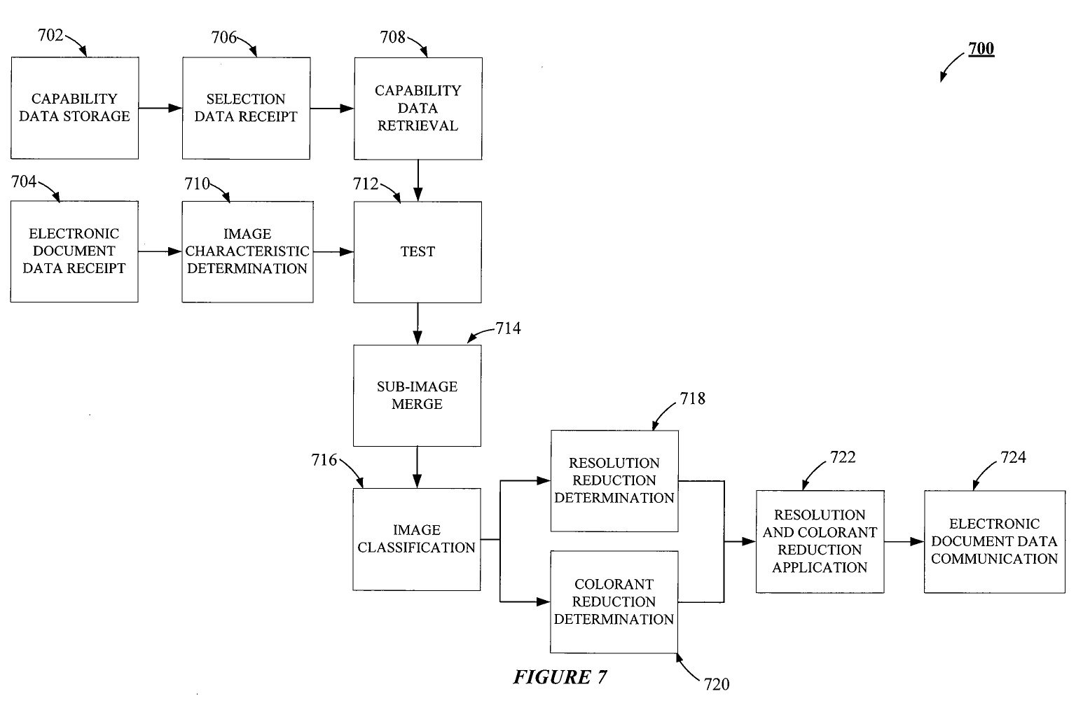

Referring now to FIG. 7, there is shown a functional block diagram 700 of the system and method for device-specific image manipulation in accordance with one embodiment of the subject application. Capability data storage 702 first occurs corresponding to the storage of data representing at least one capability associated with at least one output device in associated memory. Electronic document data receipt 704 then occurs of electronic document data that includes image data representing multiple sub-images. Selection data receipt 706 is then performed corresponding to the receipt of a selection by an associated user of at least one of the output devices. Capability data retrieval 708 then occurs representing the retrieval of output device capability data form the storage 702 corresponding to the selected 706 document output device. Image characteristic data determination 710 then occurs corresponding to the determination of image characteristics of the plurality of sub-images. A test 712 is then performed of the output device capability data retrieved 708 in accordance with the selected output device 706 relative to image characteristic data resulting from the determination 710 thereof.

A sub-image merge 714 is then performed of the plurality of sub-images of the image data into a single image in accordance with the associated determined image characteristic data 710. Image classification 716 is then determined of the merged single image in accordance with the determined image characteristic data 710. A resolution reduction determination 718 is then made in accordance with an output of the test 712 of output device capability data associated with the selected output device relative to determined image characteristic data. Next, a colorant reduction determination 720 is made in accordance with an output of the test 712 of output device capability data associated with the selected output device relative to determined image characteristic data. Application 722 is then made of the resolution reduction determination 718 and colorant reduction determination 720 to the electronic document data. Electronic document data communication 724 is thereafter performed of the electronic document data inclusive of merged single image data in accordance with applied resolution reduction and colorant reduction to the selected output device.

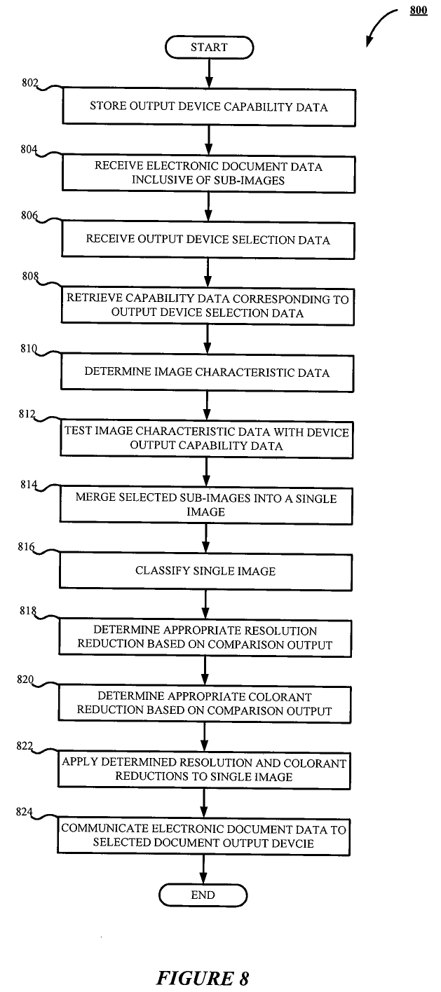

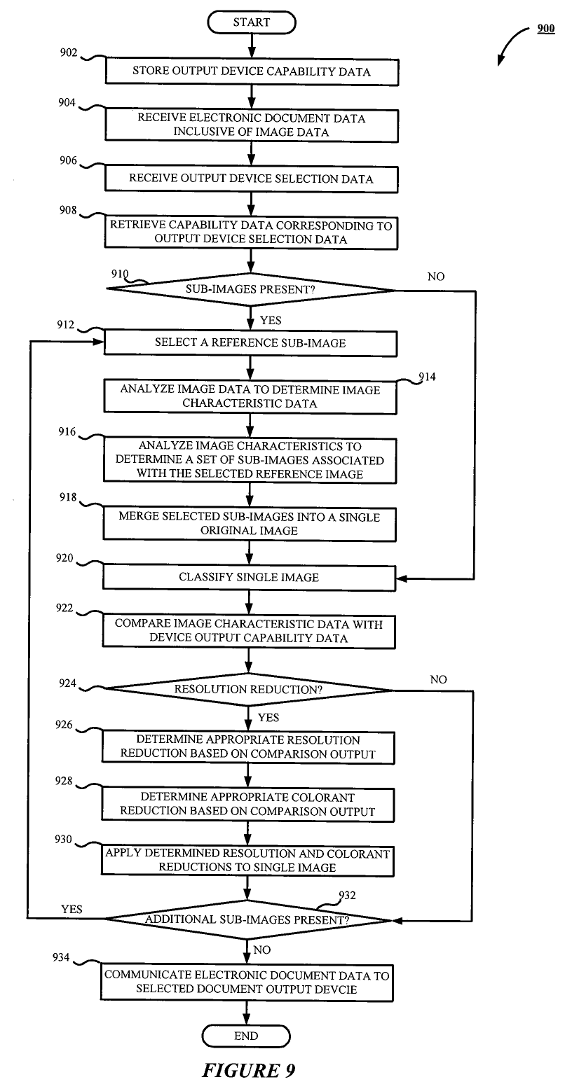

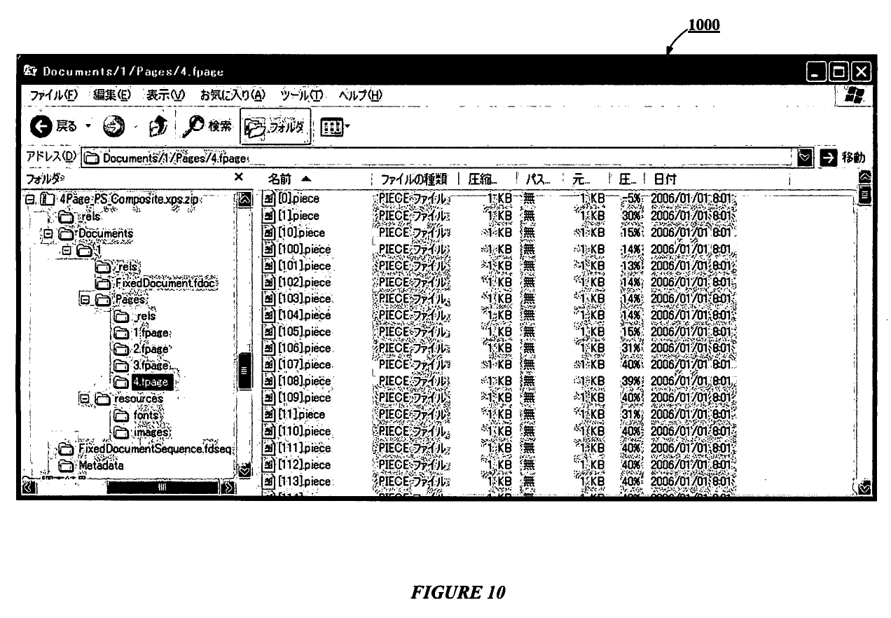

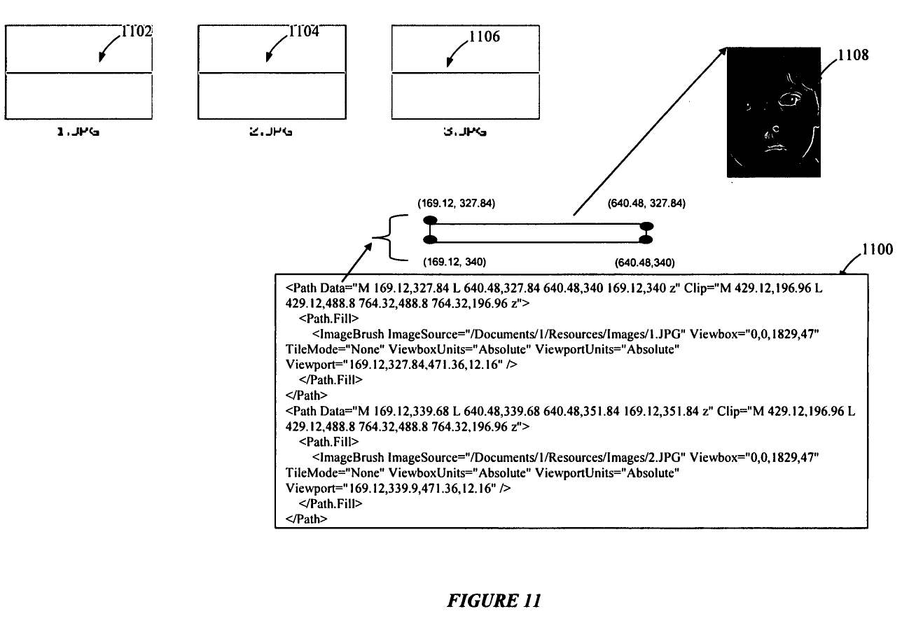

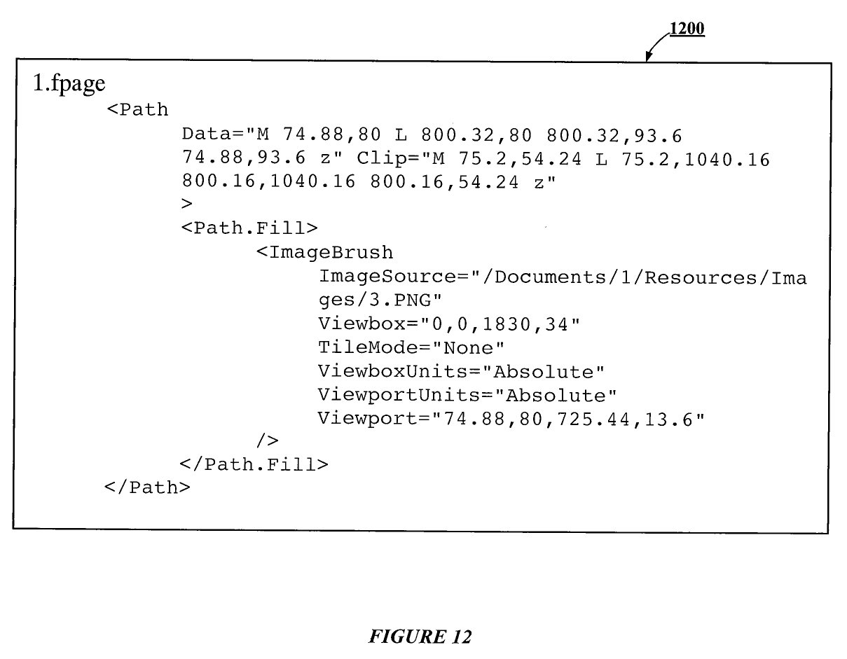

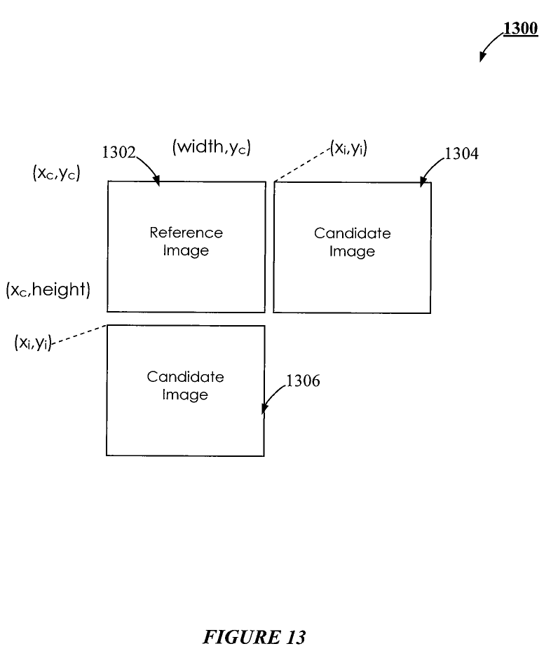

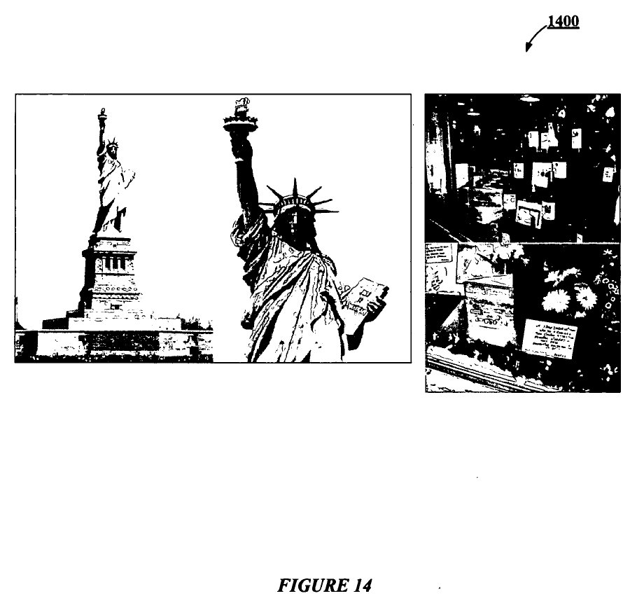

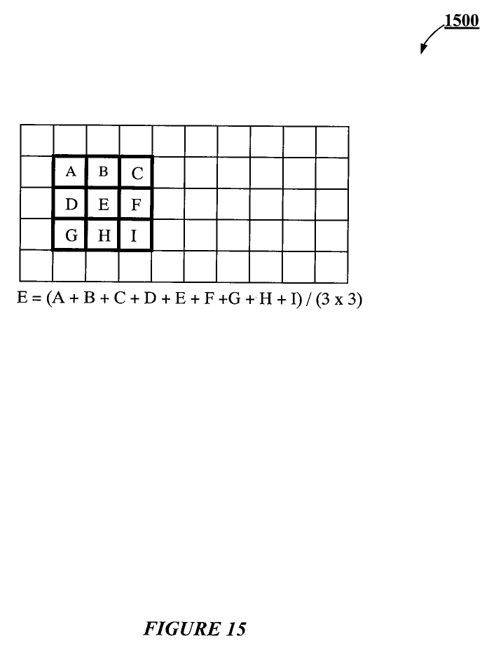

The skilled artisan will appreciate that the subject system 100 and components described above with respect to FIG. 1, FIG. 2, FIG. 3, FIG. 4, FIG. 5, FIG. 6, and FIG. 7, will be better understood in conjunction with the methodologies described hereinafter with respect to FIG. 8 and FIG. 9, and the example implementations of FIG. 10, FIG. 11, FIG. 12, FIG. 13, FIG. 14, and FIG. 15. Turning now to FIG. 8, there is shown a flowchart 800 illustrating a method for device-specific image manipulation in accordance with one embodiment of the subject application. Beginning at step 802, output device capability data corresponding to the output capabilities of available output devices, e.g. document output device 104, are stored in associated memory. At step 804, electronic document data is received by driver software on the workstation 114, the controller 108, or the like inclusive of image data corresponding to a plurality of sub-images.

Selection data is then received at step 806 from an associated user corresponding to a selected document output device 104. The driver software associated with the workstation 114 then retrieves, at step 808, capability data associated with the selected document output device 104. In accordance with one embodiment of the subject application, the capability data corresponds to the processing capability, resolution capability, available colorants, resources, consumables, and the like, associated with the selected document output device 104.

At step 810, the image data associated with the received electronic document is analyzed so as to determine associated image characteristic data. The driver software or other suitable component associated with the workstation 114 then compares the determined image characteristic data with the retrieved device output capability data at step 812. At step 814, selected sub-images are merged into a single image. Classification of the image then occurs at step 816, whereupon the single image is classified into a natural category, a scanned category, a composed category, a computer generated category, or a painting category.

The driver software or other suitable component associated with the workstation 114 then determines an appropriate resolution reduction based upon the output of the comparison of the image characteristic data and the device capability data at step 818. In accordance with one embodiment of the subject application, the resolution reduction is determined in accordance with the classification of the single image performed at step 816. At step 820, an appropriate colorant reduction is then determined in accordance with the output of the comparison between the characteristic data and the device capability data. At step 822, the determined resolution reduction and the determined colorant reduction are applied to the single image of the received electronic document data. Thereafter, at step 824, the electronic document data is communicated to the document output device 104 from the workstation 114 for further processing and output thereon.

Referring now to FIG. 9, there is shown a flowchart 900 illustrating a method for device-specific image manipulation in accordance with one embodiment of the subject application. The methodology of FIG. 9 begins at step 902, whereupon output device capability data corresponding to the output capabilities of available output devices, e.g. document output device 104, are stored in associated memory. In accordance with one example embodiment of the subject application, the output capability data is stored in memory associated with the workstation 114, e.g. a hard disk drive, or the like. The skilled artisan will appreciate that such storage is also capable of being performed by the document output device 104, e.g. accessible by the workstation 114 via the computer network 102.

At step 904, a software component, such as a printer driver, or other suitable software program interfacing the workstation 114 with the document output device 104, receives electronic document data inclusive of image data corresponding to images contained within the electronic document. In accordance with one embodiment of the subject application, the received electronic document data corresponds to an XPS document. The skilled artisan will appreciate that while reference is made herein with respect to driver software associated with the workstation 114, the subject application is capable of implementation via the controller 108 associated with the document output device 104, or any other suitable processing device as will be known in the art. Furthermore, the skilled artisan will appreciate that while reference is made herein to the document output device 104 as the selected document output device, other suitable devices, e.g. displays, mobile devices, etc., are also capable of representing a selected document output device in accordance with one embodiment of the subject application.

Following receipt of the electronic document, flow proceeds to step 906, whereupon the driver software receives output device selection data from an associated user corresponding to a document output device for output of the received electronic document data, e.g. selection data corresponding to the document output device 104 is received from the user. Those skilled in art will appreciate that such selection data is received by the driver software of the workstation 114 via a graphical user interface, web-interface, thin-client interface, or the like. At step 908, capability data representing the output capabilities associated with the selected document output device 104 is retrieved by the driver software or other component associated with the workstation 114. Suitable examples of such output capabilities include, without limitation, dots per inch (DPI) output resolution, colorant availability, resource availability, and the like.

Flow then proceeds to step 910, whereupon a determination is made whether the image data associated with the received electronic document includes one or more sub-images. In accordance with one embodiment of the subject application, a sub-image corresponds to a portion of an original image contained in an XPS document. It will be understood by those skilled in the art that the XPS specification enables the splitting of images into a plurality of sub-images for communication purposes, storage purposes, processing purposes, and the like. In such an embodiment, the determination of whether the image has been divided into sub-images is made in accordance with the frequency of images having the same dimensions and the total number of images within the XPS document. It will be appreciated by those skilled in the art that various software applications tend to divide images equally so as to take advantage of the aforementioned benefits. Such format of the splitting of an original image is dictated by the software application which generates the electronic document data. A suitable example of such an application is WINDOWS PHOTO GALLERY by the MICROSOFT CORPORATION, which separates an image into a plurality of images having a height of 500 pixels and ignoring the width. This approach covers even size pieced images. The skilled artisan will appreciate, however, that images are also capable of being broken into uneven sized pieces. In order to ascertain such images, additional indicators, such as the sharing of the same clip path, which point to a set of split images, are used. The XPS structure uses a series of text files that indicate the structure and formatting of the associated XPS file. One of these components includes the fixed page (fpage) component. The fpage component is illustrated in the XPS structure file, depicted in the screenshot 1000 shown in FIG. 10.

The files of the XPS structure include information on the x and y coordinates of image files on a particular page of an XPS document. FIG. 11 gives a clip path 1100 of an example of a relationship between a fixed page document and the images 1102-1108. Paths of a linked connection point gives a further indication of a separated image 1102-1106, and also provides a means of re-merging the image 1108. In addition, the skilled artisan will appreciate that another useful feature in clip path 1100 is the indicator is capable of corresponding to x-y coordinates of each image 1102-1108. When no sub-images are detected, flow proceeds to step 920, whereupon the image is classified in accordance with the methodology discussed in greater detail below and operations with respect to FIG. 9 continue as set forth hereinafter.

Returning to step 910, upon the detection of sub-images in the image data of the received electronic document, flow proceeds to step 912. At step 912, a reference sub-image is selected from among the plurality of sub-images and corresponding to a portion of an original image contained in the received electronic document. At step 914, the driver software component associated with the workstation 114 analyzes the reference sub-image data associated with the received electronic document to determine image characteristic data. In accordance with one embodiment of the subject application, the image characteristic data includes, for example and without limitation, bit-depth, color space, number of channels, resolution, and the like.

At step 916, the determined image characteristics are analyzed by the driver software to determine a set of sub-images associated with the selected reference image. That is, image characteristics of each sub-image are analyzed with respect to the image characteristics of the selected reference image to determine whether a sub-image corresponds to the same original image associated with the selected reference image. In accordance with one embodiment of the subject application, the software driver or other suitable component associated with the workstation 114, the controller 108 or the like, first selects the reference image, then performs a sequential search on following images so as to determine whether or not these candidate images are valid for image consolidation with the selected reference image.

An analysis is first performed of the clip path field of the XPS <Path> tag 1200 of FIG. 12, which contains the image of interest. As will be understood by those skilled in the art, the clip path defines a relative region of where the image may appear within the XPS document. The skilled artisan will appreciate that such a definition does not necessarily imply that all images within this region are of the same single image from which they were separated. Furthermore, not all documents include the clip path field, as the skilled artisan will understand that such a clip path field is optional in an XPS document. However, the clip path does provide an indication whether a sub-image, e.g. a candidate image, is not of the same original image. Thus, the skilled artisan will appreciate that a different clip path gives rise to an assumption that the sub-image is of a different original image than that of the reference image. Therefore, the first condition is specified as follows:

Given a reference image with ClipPath, and the clip path of an image in question ClipPath_{y}

```
If (ClipPathₓ != ClipPath_{y})
    /* Input image is not related to reference Image */
Else
    /* continue checking */
```

Thereafter, standard characteristic traits are analyzed, including, for example and without limitation, bit-depth, colour space, number of channels and resolution. Thus, images having different image characteristics, provide a suitable indication of whether or not a sub-image is part of a single combined original image.

Following the clip path condition, all characteristics must be the same between the reference image and the candidate image

| | |
|---|---|
| If (bitdepthₓ | != bitdepth_{y} |
| \|\| colorspaceₓ | != colorspace_{y} |
| \|\| resolutionₓ | != resolution_{y} |
| \|\| numOfChannelsₓ | != numOfChannels_{y}) |

```
      /* Input image is not related to the reference image */
Else
      /* Continue Check */
```

The positioning of the candidate image is then analyzed with respect to the reference image within the XPS document. It will be appreciated by those skilled in the art that the position of a sub-image is determined by a required viewport field specified within the imagebrush element. An example of the viewport within the imagebrush element is illustrated in FIG. 12, and is further narrowed to:

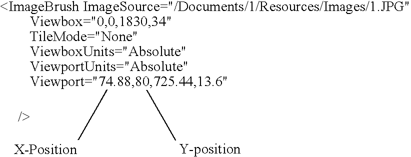

Given the X and Y points, a connection point is then established using the width and height of the reference image. FIG. 13 illustrates a set of reference and candidate images 1300 in accordance with one embodiment of the subject application. As illustrated in FIG. 13, a horizontal connection occurs when the candidate image 1306 is attached at the same width position as the reference image 1302 while having a Y-coordinate value equivalent to the reference image height relative to the position. A vertical connection is established when the candidate 1304 has an X value equivalent to the reference image width relative to the position and having the same Y co-ordinate as the reference image 1302.

The general condition is applied as follows:

```
If((xᵢ,yᵢ)± Eᵣ== (X_{c}, height_{c}))
      /* Image is attached horizontally */
Else if ((xᵢ,yᵢ) ± Eᵣ == (width_{c}, y_{c}))
      /* Image is attached vertically */
Otherwise
      /* Candidate Image is not valid to be attached to the
reference image */
```

It will be appreciated by those skilled in the art that some applications are capable of rounding off values from 2 decimal places to 0 decimal places. In such circumstances, the skilled artisan will appreciate that it is often acceptable to have minor gaps or slightly overlapping images as these factors are not significant enough to be detected by the human eye and additionally, may not be noticed by printing devices. Therefore and error margin (Eᵣ) of 0.25 is introduced for the calculation of these positions.

At this point, the candidate image is considered to be a likely valid image for image merging. However there is one particular situation that may occur in an XPS document illustrated in FIG. 14, which depicts non-continuous image content 1400 over adjacent images. The flexibility of XPS allows images to be positioned in such a way. This is often created for the visual effect of a document, and the probability of such documents with images situated like those illustrated in FIG. 14 is very high. Thus, to prevent the merge of these images, edge analysis is implemented in accordance with one embodiment of the subject application. That is, the edge flow direction between the boundaries of the reference and candidate image is analyzed. In accordance with a further embodiment of the subject application an additional mechanism is implemented involving the calculation of the edge strengths and directions between the images.

Preferably, the edge flow is used to determine whether a boundary exists and to determine if the flow of the image is continuous between the images of interest. To determine the edge flow, Sobel Masks (as shown below) are used to obtain the gradient magnitudes of a particular pixel.

| Gx | | | Gy | | |
|---|---|---|---|---|---|
| −1 | 0 | +1 | +1 | +2 | +1 |
| −2 | 0 | +2 | 0 | 0 | 0 |
| −1 | 0 | +1 | −1 | −2 | −1 |

Each mask is applied separately to a pixel to obtain a gradient magnitude in the x-direction and y-direction. These magnitudes can then be substituted into an inverse tangent to obtain the edge direction:

Edge Direction=tan⁻¹(Gy/Gx)

Given the edge direction value, it is then translated into a direction that can be traced on the image. The edge direction is summarized into 4 directions based on the region diagram below:

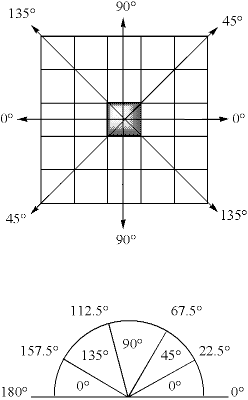

From the preceding images, any edge direction falling in between 0° to 22.5° and 157.5° to 180° is classified to have an edge direction along the horizontal. Any edge direction falling between 22.5° and 67.5° are set to 45°, which is in the top-right and bottom-left direction. Any edge direction falling between 112.5° and 157.5° are set to 135°, that's in the negative diagonal (i.e. top-left, bottom-right). Lastly, any edge direction that falls between 112.5° and 67.5° is considered to be moving in the vertical direction at 90°.

From these directions given, a boundary can be identified by the following edge conditions: if all edge directions are in the opposite direction, a boundary exists; and if all edge directions move in the horizontal direction (0°) on the reference or the candidate image, then a boundary exists.

The skilled artisan will appreciate that there are circumstances wherein images have boundary noise, artifacts or simply the odd set of boundary pixels which have a variety of artifacts. Such occurrences are countered by the inclusion of an error ratio of 0.1, which excludes these anomalies. Therefore, the boundary comparison is given as follows:

```
If(eDo > 0.9% of β)
      /* Boundary exists */
If(eHor_{c} > 0.9% of β)
      /* Boundary exists */
If(eHorᵣ > 0.9% of β)
      /* Boundary exists */
```

Where eDo is the total number of comparisons between the reference boundary pixel with the candidate boundary pixel that have an opposite edge direction, and eHorr and eHor_{c} are each the total number that have a pixels that have a 0 direction in the reference and candidate respectively and β is the total number of pixels that are aligned for comparison depending on the attachment type (i.e. horizontally=total width pixels or vertically=total height pixels).

It will be understood by those skilled in the art that edge direction does not indicate content that is contained within the sub-images. Therefore, to further emphasize the edge flow, the edge strength is obtained and the edge strengths between the boundaries of the sub-images are compared. A selected number of rows or columns, depending on the connection type, are selected from the reference and candidate images associated with the connection boundary. The edge strength between sub-images at the connection boundary is likely to have similar strengths as the content within these regions are likely to be very similar or even the same.

Given the edge strength of the reference image is EStrᵣ and candidate image with edge strength represented as EStr_{c}:

```
If (EStr_{C} > 90% of EStrᵣ &&EStr_{c} < 110% of EStrᵣ)
      /* Image is valid for merge */
Else
      /* Image is not valid for merge */
```

Where, a 10% error of edge is allowed in this comparison. Additionally, edges with edge strengths less than 65 are set to 0 to minimize the effect of noise.

The selected set of sub-images are then merged into a single original image, at step 918, by the driver software associated with the workstation 114, as will be understood by those skilled in the art. In accordance with one embodiment of the subject application, the merging of such sub-images is accomplished by performing an analysis of the image characteristics, the positioning of the individual sub-images, and a determination of whether the sub-images once belonged to the same larger image. Suitable methods of performing such an analysis include, for example and without limitation, image edge analysis on the boundary of each sub-image. It will be appreciated by those skilled in the art that the combined image enables proper utilization of consequent image operations, such as, for example and without limitation, resolution reduction, white balancing, and other such operations dependent upon overall image features. In accordance with one particular embodiment of the subject application, various image data characteristics, such as, for example and without limitation, the use of path data, clip path, edge information along the merge boundary, are used to determine whether adjacent images are actual candidates for merging. According to a further embodiment of such an example embodiment, after merging, the path data is consolidated, as will be appreciated by those skilled in the art.

Returning to FIG. 9, after merging at step 918, flow then proceeds to step 920, whereupon the single original image is suitably classified into a category describing the image, such as, for example and without limitation a natural, scanned, composed, computer generated, painting, or other such categories. It will be understood by those skilled in the art that the natural image category corresponds to images that have been captured through optical lenses, e.g. optical anti-aliasing. Thus, these analogue images are converted to electronic form via an optical device and typically a wide variety of color values while exhibiting some noise in the process of the conversion. The skilled artisan will appreciate that the scanned image category represents those images that have been obtained through a scanner. Scanner's generally have scan line based reading system which generally produces images with more noise compared to Natural images. The skilled artisan will understand that scanners are generally used to target printed targets and thus they are half-toned. The composed image category, as will be understood by those skilled in the art, corresponds to images that are created using existing applications, which are capable of composing a mixture of the other image-types as one image. Generally, these images are treated as computer generated due to the process of storing and manipulating via an imaging application. Images classified in the computer generated image category are purely generated from the textures available from applications, and tend to contain no noise, have sharper edges, and a lesser number of colors than those images in the natural category. The skilled artisan will appreciate that the painting image category corresponds to those images that exhibit similar traits as those images in the computer generated category and natural image category, representing the features of oil paintings.

The skilled artisan will appreciate that the classification of an image provides the subject system and method with the ability to determine whether the image is suitable for further resolution reduction. According to one embodiment of the subject application, the classification is performed via the application of a two-step algorithm. The first step in such application is based upon the standard image characteristics and the XPS input to output pixel ration that satisfy a given set of rules to determine whether such an image is suitable for further resolution reduction. The second step in such an application involves the calculation of a series of metrics, based upon the values from the raw image data and the image characteristic data. These values are then compared with a derived rule set to determine whether the image has photographic-like traits, which allow for greater resolution reduction. Such rules include, for example and without limitation, overall edge strength, region based edge strength and halftone detection etc. within an XPS print path.

At step 922, the image characteristic data is compared with the device output capability data. A determination is then made at step 924 whether or not to apply resolution reduction to the image. In accordance with one embodiment of the subject application, the classification of the image is taken into account when determining whether or not to apply resolution reduction. Thus, for example and without limitation, when an image is classified as a natural image, e.g. a photograph, resolution reduction is warranted. However, when the image is classified into the computer generated category, resolution reduction will not be applied below a certain threshold, e.g. the maximum supported by the document output device 104, a preselected value, e.g. 600 DPI, or the like. When resolution reduction is not warranted for the classified image, flow proceeds to step 932, whereupon a determination is made whether any other sub-images remain in the document. That is, whether more than one original image was present in the document such that a set of sub-images corresponds to one original image and another set corresponds to another original image. A positive determination at step 932 results in a return to step 912, whereupon a reference image associated with another original image is selected.

Returning to step 924, when it is determined that resolution reduction is to be applied to the merged image, flow proceeds to step 926. At step 926, an appropriate resolution reduction is determined in accordance with the comparison output of step 922. In one particular embodiment, the classification of the image is also used to determine an appropriate resolution reduction to be applied to the merged image. Resolution reduction in accordance with one embodiment of the subject application is suitably accomplished via the use of an anti-aliasing filter. An example of simple anti-aliasing filters is the averaging filter 1500 illustrated in FIG. 15.

The skilled artisan will appreciate that the averaging filter 1500 illustrated in FIG. 15 operates by sliding a default set size window then averaging the common channels of the input image then placed in the corresponding output. It will be understood by those skilled in the art that the use of smaller windows will process faster due to the reduced amount of calculations required while also benefiting from maintaining detail. However, such smaller windows typically keep noise related data existing on the image that is not desired. It will also be understood by the skilled artisan that larger windows typically smooth the image so as to remove any noise which is capable of hindering the human perception of quality. Those skilled in the art will understand that via a large window, smoothing of images is capable of occurring with respect to images having high edge details thereby resulting in a loss of information on the image. Furthermore, the larger window requires more iterations and therefore longer processing time.

In accordance with one embodiment of the subject application, rectification of window selection is based on the image classification, wherein a selective window is implemented to make a selective choice between the window sizes. The window sizes selected are either 2×2 or 3×3. It will be appreciated by those skilled in the art that window sizes above these selected generally reduces performance and result in image detail loss.

Where the ratio output is determined by the number of pixels of an image over the number of pixels required to fill a given XPS region, a 2×2 window is used for images when the ratio of pixels is between 1.0 and 3.0, thereby minimizing the effects edge loss for image that requires less pixel reduction. Where the ratio output is determined by the number of pixels of an image over the number of pixels required to fill a given XPS region, a 3×3 window is used for ratio output of greater than 3.0, using the most amount of pixels for reduction while maintaining a significant amount of detail of an image. Any ratio below 1.0 is not resolution reduced, as a reduction of the image required to fill a space larger than the pixel it contains would indicate that the image is scaled up, typically displaying pixilation of the image.

Following the determination of an appropriate resolution reduction, flow proceeds to step 928, an appropriate colorant reduction is determined in accordance with the output of the comparison step 922. The determined resolution and colorant reductions are then applied to the single original image at step 930 and flow proceeds to step 932. In accordance with one embodiment of the subject application, the image resolution reduction is applied via an averaging filter while also allowing a window size to be dynamically selected based upon the input-output pixel ratio as determined by the image classification. The skilled artisan will appreciate that suitable colorant reduction corresponds to the driver software correlating the output color capability of the document output device 104 with the colors of the image data, e.g. a monochromatic document output device 104 results in a colorant reduction from the color space of the original image to the monochromatic output of the device 104.

Upon a negative determination at step 932 that no additional sub-images remain for processing by the driver software associated with the workstation 114, flow proceeds to 934, whereupon the electronic document is communicated to the selected document output device 104 from the workstation 114 via the computer network 102. It will be understood by those skilled in the art that the subject application is capable of implementation directly at the document output device 104 such that the software driver is operative on the controller 108, whereupon the controller 108 communicates the document data to an associated output engine of the document output device 104.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for printer driver-based image manipulation, comprising:
a data input;
a data storage storing data representative of at least one capability associated with at least one of a plurality of output devices;
the data storage storing electronic document data inclusive of image data representative of a plurality of sub-images, the plurality of sub-images having image characteristic data associated therewith;
a selection input for selection data corresponding to a selection of at least one output device;
a comparator operable between output device capability data associated with the selected output device relative to image characteristic data;
a merged-image generator operable on the plurality of sub-images and image characteristic data so as to generate a single image corresponding thereto;
is a secondary comparator operable between an output of the merged-image generator and the image characteristic data relative to an image classification associated therewith;
a resolution reduction application control operable on the single image in accordance with the output device capability data associated with the selected device relative to the associated image characteristic data;
a colorant reduction application control operable on the single image in accordance with the output device capability data associated with the selected device relative to the associated image characteristic data; and
an image output in data communication with the selected output device and operable on the single image in accordance with an output of the resolution reduction application control and the colorant reduction application control.

2. The system of claim 1, further comprising:
a selector configured for selecting at least one reference image from among the plurality of sub-images associated with the received electronic document data;
a sub-image selection control operable on a selected plurality of sub-images associated with the selected reference image in accordance with the image characteristic data; and wherein
the merged-image generator is operable on the selected plurality of sub-images associated with the selected reference image so as to generate a single image corresponding thereto.

3. The system of claim 2, wherein the image classification corresponds to a classification of the single image as at least one of the group consisting of a natural image, a scanned image, a composed image, a computer-generated image, and a painted image; and
wherein the resolution reduction application control is operable to determine an amount of resolution reduction in accordance with an image classification.

4. The system of claim 2, further comprising:
the comparator operable on image characteristic data of each of the plurality of sub-images relative to the selected reference image;
an adjacent image control operable in accordance with an output of the comparator so as to determine adjacent sub-images corresponding to the selected reference image;
wherein the merged-image generator is operable on the adjacent sub-images output by the adjacent image control relative to the associated image characteristic data; and
wherein the image characteristic data of each sub-image includes at least one of the group consisting of path data, clip path data, and edge information data along a merge boundary.

5. The system of claim 1, wherein the electronic document data is markup language paper specification format document data.

6. The system of claim 1, wherein the capability data includes data representative of at least one of the group consisting of a dots per inch output resolution, a colorant availability, and a resource availability; and wherein the image characteristic data includes data representative of at least one of the group consisting of bit-depth, color space, number of channels, and resolution.

7. A method for printer driver-based image manipulation, comprising the steps of:
storing, in associated memory, data representative of at least one capability associated with at least one of a plurality of output devices;
receiving electronic document data inclusive of image data representative of a plurality of sub-images;
receiving selection data from an associated user, the selection data corresponding to a selection of at least one selected output device;
retrieving, from the associated memory, output device capability data representative of at least one capability associated with output device in accordance with received output device selection data;
determining image characteristic data corresponding to the plurality of sub-images;
testing output device capability data associated with the selected output device relative to determined image characteristic data;
merging the plurality of sub-images of the image data into a single image in accordance with the determined image characteristic data associated therewith;
classifying the merged single image in accordance with the determined image characteristic data;
determining a resolution reduction in accordance with an output of the testing of output device capability data associated with the selected output device relative to determined image characteristic data;
determining a colorant reduction in accordance with an output of the testing of output device capability data associated with the selected output device relative to determined image characteristic data;
applying determined resolution reduction and colorant reduction to merged single image data of the received electronic document data; and
communicating electronic document data inclusive of merged single image data in accordance with applied resolution reduction and colorant reduction to the selected output device.

8. The method of claim 7, further comprising the steps of:
selecting at least one reference image from among the plurality of sub-images associated with the received electronic document data.
determining a selected plurality of sub-images associated with the selected reference image in accordance with determined image characteristic data; and
merging the selected plurality of sub-images associated with the selected reference image into a single image.

9. The method of claim 8, wherein the single image is classified as at least one of the group consisting of a natural image, a scanned image, a composed image, a computer-generated image, and a painted image; and
wherein the step of determining resolution reduction further comprises determining an amount of resolution reduction in accordance with an output of the classification step.

10. The method of claim 8, wherein the step of merging the selected plurality of sub-images further comprises the steps of:
testing image characteristic data of each of the plurality of sub-images relative to the selected reference image;
determining to adjacent sub-images in accordance with an output of the testing; and
merging a sub-image with determined adjacent sub-image in accordance with associated image characteristic data,
wherein the image characteristic data of each sub-image includes at least one of the group consisting of path data, clip path data, and edge information data along a merge boundary.

11. The method of claim 7, wherein the electronic document data is markup language paper specification format document data.

12. The method of claim 7, wherein the capability data includes data representative of at least one of the group consisting of a dots per inch output resolution, a colorant availability, and a resource availability.

13. The method of claim 7, wherein the image characteristic data includes data representative of at least one of the group consisting of bit-depth, color space, number of channels, and resolution.

14. A system for printer driver-based image manipulation, comprising:
storage means adapted for storing, in associated memory, data representative of at least one capability associated with at least one of a plurality of output devices;
receiving means adapted for receiving electronic document data inclusive of image data representative of a plurality of sub-images;
selection means adapted for receiving selection data from an associated user, the selection data corresponding to a selection of at least one selected output device;
retrieval means adapted for retrieving, from the storage means, output device capability data representative of at least one capability associated with output device in accordance with received output device selection data;
determining means adapted for determining image characteristic data corresponding to the plurality of sub-images;
testing means adapted for testing output device capability data associated with the selected output device relative to determined image characteristic data;
merging means adapted for merging the plurality of sub-images of the image data into a single image in accordance with the determined image characteristic data associated therewith;
classification means adapted for classifying the merged single image in accordance with the determined image characteristic data;
resolution determination means adapted for determining a resolution reduction in accordance with an output of the testing means corresponding to output device capability data associated with the selected output device relative to determined image characteristic data;
colorant reduction determination means adapted for determining a colorant reduction in accordance with an output of the testing means corresponding to output device capability data associated with the selected output device relative to determined image characteristic data;
application means adapted for applying determined resolution reduction and colorant reduction to merged single image data of the received electronic document data; and
communication means adapted for communicating electronic document data inclusive of merged single image data in accordance with applied resolution reduction and colorant reduction to the selected output device.

15. The system of claim 14, further comprising the steps of:
selecting at least one reference image from among the plurality of sub-images associated with the received electronic document data;
determination means adapted for determining a selected plurality of sub-images associated with the selected reference image in accordance with determined image characteristic data; and
merging means adapted for merging the selected plurality of sub-images associated with the selected reference image into a single image.

16. The system of claim 15, wherein the classification means classifies the single image as at least one of the group consisting of a natural image, a scanned image, a composed image, a computer-generated image, and a painted image; and
wherein the resolution reduction determination means further comprises means adapted for determining an amount of resolution reduction in accordance with an output of the classification means.

17. The system of claim 15, wherein the means adapted for merging the selected plurality of sub-images further comprises:
testing means adapted for testing image characteristic data of each of the plurality of sub-images relative to the selected reference image;
means adapted for determining to adjacent sub-images in accordance with an output of the testing means; and
means adapted for merging a sub-image with determined adjacent sub-image in accordance with associated image characteristic data,
wherein the image characteristic data of each sub-image includes at least one of the group consisting of path data, clip path data, and edge information data along a merge boundary.

18. The system of claim 14, wherein the electronic document data is markup language paper specification format document data.

19. The system of claim 14, wherein the capability data includes data representative of at least one of the group consisting of a dots per inch output resolution, a colorant availability, and a resource availability.

20. The system of claim 8, wherein the image characteristic data includes data representative of at least one of the group consisting of bit-depth, color space, number of channels, and resolution.
